(19) United States
(12) Patent Application Publication
(10) Pub. No.: US 2003/0023414 A1
(43) Pub. Date: Jan. 30, 2003

(54) Method for passenger classification using a seat mat in the vehicle seat

(76) Inventors: Thomas Lich, Schwaikheim (DE); Frank Mack, Stuttgart (DE)

Correspondence Address: KENYON & KENYON, ONE BROADWAY, NEW YORK, NY, 10004, US

(21) Appl. No.: 09/962,948

(22) Filed: Sep. 24, 2001

(30) Foreign Application Priority Data
Sep. 23, 2000 (DE) 100 47 189.7-34

(51) Int. Cl. G06F 17/10

(52) U.S. Cl. 703/2

(57) ABSTRACT

A method is proposed for passenger classification using a seat mat in a vehicle seat, that functions so as to determine the magnitude of a coherent area of active matrix elements. Using the active matrix elements, a seat profile is generated, it being determined, using an operation parameter, how large the largest coherent area in the seat profile is. In this way, it is possible to distinguish between persons and objects. In this context, further result matrices are determined from a seat profile and specifically using a logical operation. The sum of the active matrix elements of one result matrix is added up and weighted. From these weighted sums, an operation parameter is calculated, which is used for the passenger classification, optionally in connection with further characteristics, which are derived from the seat profile.

### FIELD OF THE INVENTION

The present invention relates to a method for passenger classification using a seat mat in the vehicle seat.

### BACKGROUND OF THE INVENTION

From K. Brillen, L. Federspiel, P. Schoclanehl, B. Serban, and W. Sherril, “Occupant Classification System for Smart Restraint Systems,” SAE Paper 1999, pp. 33-38, pressure sensors are known which are inserted in a seat mat for a vehicle seat and are arranged in a matrix. The pressure sensors in response to increased resistance have reduced electrical resistance. In this context, the pressure sensors can be divided into active and inactive matrix elements. From these matrix elements, a seat profile can be determined so as to ascertain characteristics for classifying passengers.

### SUMMARY OF THE INVENTION

In contrast, the method according to the present invention for passenger classification using a seat mat in the vehicle seat has the advantage that ambiguities in characteristics such as the covered seat surface are avoided. In particular, using the method according to the present invention, it is established, how coherent the active matrix elements are, in particular, how large the largest coherent area is. In this way, it is particularly simple to distinguish between a person and an object on the vehicle seat, above all if a further characteristic is used for the passenger classification. A person will generate a coherent area of matrix elements on the seat mat. An object such as a child seat will generate smaller coherent areas of active matrix elements in the seat profile. In this way, it is possible to make a simple distinction using the method according to the present invention. In response to objects that also generate a large coherent area of active matrix elements in the seat profile, a further characteristic is then brought into play for the classification. In this context, the matrix elements can be logically linked to each other either in columns or rows or in diagonals. In this context, the diagonal connection has the advantage that a V-profile is detected, which indicates a typical sitting position of a person whose thighs are resting on the seat mat.

The method according to the present invention also provides further values for passenger classification, which on the whole are independent of absolute measuring values.

It is particularly advantageous that the logical operation which connects matrix elements to the nearest result matrix for purposes of generation is an AND operation.

In addition, it is advantageous that the factor which provides the weighting of the sum of the active matrix elements of a result matrix is calculated from the rank of the result matrix. The rank of a result matrix reflects how many logic operations of result matrices have led to this new result matrix. Therefore, the value of a matrix having a higher rank is also assigned a high value, because this implies, assuming there are active matrix elements, that the area of the active matrix elements in the first result matrix is a large coherent area.

In addition, it is advantageous that the operation parameter, which is calculated from the sum of the active matrix elements of a specific result matrix, is linked to a further characteristic such as the weight estimate or the ischial tuberosity spacing, in order thus to determine the passenger classification. In this way, the characteristic that is determined using the method according to the present invention is enhanced by complementary characteristics.

Finally, it is also advantageous that a device exists for carrying out the method according to the present invention, the device having a seat mat, pressure sensors, and a processor and being connected to a control unit for restraint systems.

### BRIEF DESCRIPTION OF THE DRAWINGS

FIG. 1 depicts a block diagram of the device according to the present invention.

FIG. 2 depicts the calculation of the result matrices.

FIG. 3 depicts the flowchart of the method according to the present invention.

### DETAILED DESCRIPTION

Pressure sensors in a seat mat, which are arranged in a sensor matrix, can be active or inactive in accordance with the person or object. The surface that is covered by the person or the object results in active pressure sensors. The number of active pressure sensors does not yet provide information as to whether it is a person or an object. For example, a child seat can also result in the same number of active pressure sensors as a child. The decisive circumstance therefore is, how coherent the active pressure sensors in the sensor matrix are. Therefore, according to the present invention, using the method according to the present invention for passenger classification using a seat mat in the vehicle seat, it is determined from the seat profile and the active pressure sensors, whether the active pressure sensors in the sensor matrix constitute a coherent area. The pressure sensors that indicate a pressure load are then characterized as active matrix elements, whereas the other pressure sensors are characterized as inactive matrix elements.

The pressure sensors are linked to each other by a logical operation either by columns or by rows or by diagonals, in order finally to obtain a new result matrix. The active matrix elements from result matrices calculated in this manner are added up and are weighted using a factor. This factor is derived from the rank of the matrix, which indicates from how many result matrices the specific result matrix was calculated. The sum of the individual result matrices is then added up yielding an operation parameter. The operation parameter is a measure as to how coherent the active matrix elements are and is therefore a characteristic for passenger classification. By linking the operation parameter to a further characteristic such as the weight estimate or the ischial tuberosity spacing, a more reliable passenger classification is possible.

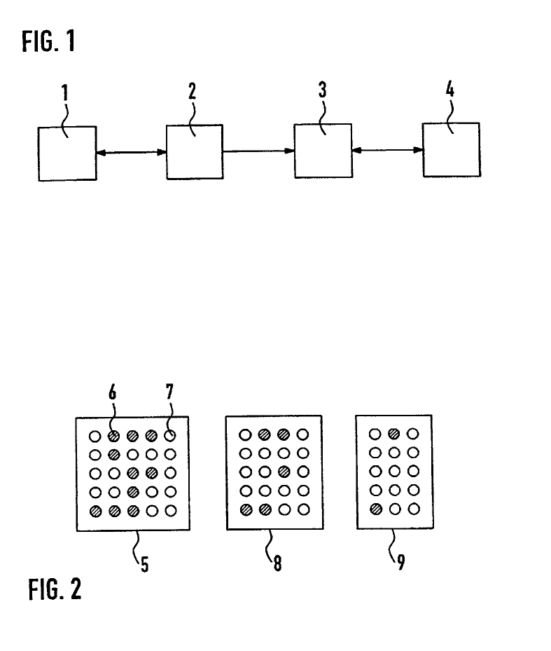

FIG. 1 as a block diagram depicts the device according to the present invention for evaluating a seat profile from a vehicle seat. A seat mat 1 is connected via a data input/output to a processor 2. Processor 2 is connected via a first data input/output to a control unit 4 for a restraint system 5. Control unit 4 is connected via a second data input/output to restraint system 5. Processor 2 functions as the control unit for seat mat 1.

Seat mat 1 sequentially supplies the individual sensor values as current values to processor 2, sensor mat 1 having an analog/digital converter, which digitizes these current values. The pressure sensors arc arranged in a matrix. Processor 2 applies voltages to the rows and columns, so that in accordance with the principle of the balanced bridge, no currents flow through the pressure sensors. In response to an increased pressure, the pressure sensors have reduced resistance. If processor 2 surveys the individual pressure sensors in the sensor matrix, then processor 2 changes the voltages applied at the rows and columns such that a current flows through each individual pressure sensor. This current is measured, is digitized by the analog/digital converter, and is then transmitted to processor 2. From the current values, processor 2 calculates the resistances of the individual pressure sensors.

Processor 2 now determines from the seat profile a result matrix having active and inactive matrix elements. This is carried out here on the basis of a threshold value comparison, resistance values that lie below the preestablished threshold value resulting in active matrix elements, whereas resistance values that lie above the threshold value result in inactive matrix elements. This derives from the fact that the pressure sensors in seat mat 1 have a lower resistance value in response to an increased pressure load.

In FIG. 2, a first result matrix 5 is depicted. First result matrix 5, which is generated from the resistance values of the sensor elements, has the rank one, since result matrix 5 has not been derived from any other result matrix. Active matrix elements 6 are filled in, whereas inactive matrix elements 7 form empty circles. Processor 2 now adds up active matrix elements 6 and weights them using the rank of first result matrix 5. Thus the first weighted sum is generated. There are 10 active matrix elements 6 here and the rank of the matrix is one, so that the sum yields the value 10.

In second result matrix 8, which was formed from first result matrix 5, there are five active matrix elements. The formation of second result matrix 8 was achieved through a logical AND operation of the matrix elements of different and adjoining columns. Therefore, it is clear that in second result matrix 8, one column is missing and that only active matrix elements 6, which have an active matrix element as a neighbor result in an active matrix element in second result matrix 8. The sum of the active matrix elements in second result matrix 8 is five and is multiplied by the rank of second result matrix 8, i.e., two, so that here as well the result is 10. Third result matrix 9, which also was formed using a logical AND operation of the adjoining matrix elements with regard to the columns, also has one column fewer than second result matrix 8. In the third result matrix, there remain only two active matrix elements 6, because two pairs of active matrix elements 6 were located only in two rows of second result matrix 8. The sum of this result matrix is two, multiplied by the rank three of third result matrix 9, so that the result is six. The operation parameter, which is yielded from the weighted sums of individual result matrices 5, 8, and 9, is therefore 26. This logic parameter is now carried over, for example, into a weight estimate, so as to be linked with further characteristics derived from the seat profile, to make possible the passenger classification. For this purpose, processor 2 can use, for example, the ischial tuberosity spacing and a weight estimate. Finally then, the result of this is the passenger classification, which processor 2 conveys to control unit 3 for restraint systems 4. Therefore, control unit 3 has available to it the data which permit restraint system 4, in the event of a triggering, to be triggered in such a way that the probability of injury by restraint system 4 is minimized.

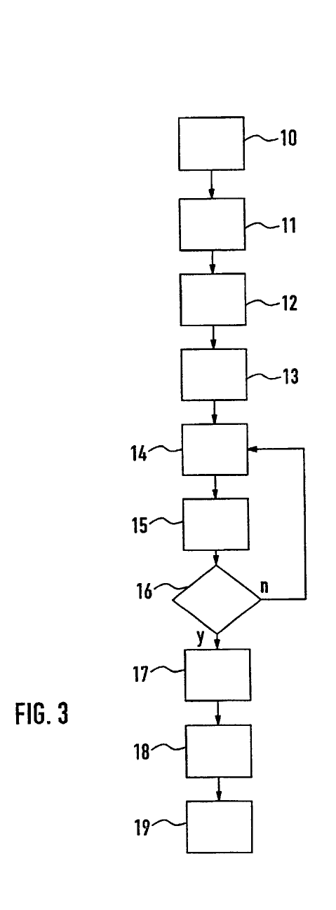

In FIG. 3, the method according to the present invention is depicted as a flowchart. In method step 10, the sensor values from sensor mat 1 and the sensor matrix located in it are determined. In method step 11, as was described above, the sensor values are read out, digitized, and conveyed to processor 2. In method step 12, processor 2 arranges the sensors into active and inactive matrix elements, the resistance values of the sensors being compared with a threshold value. This then results in a seat profile having active and inactive matrix elements, the matrix elements in each case representing one pressure sensor.

In method step 13, a first result matrix 5 is therefore determined. From this result matrix, the first sum is calculated, which is weighted using the rank of first result matrix 5.

In method step 14, the matrix elements of first result matrix 5 are linked using the logical AND-operation to their neighboring matrix elements from the adjoining columns, row by row. The result of this is then second result matrix 8. In method step 15, the sum for second result matrix 8 is then determined therefrom.

In method step 16, the termination conditions for the method according to the present invention are checked. The termination conditions are fulfilled if no further active matrix elements are present or if a logical operation is no longer possible, because only one column or one row remains. If the termination conditions are not fulfilled, then there is a return to method step 14, to generate the next result matrix. If at least one of the termination conditions is present, then in method step 17 the operation parameter is derived, specifically by an adding-up procedure, from the individual weighted sums that were calculated for the individual result matrices.

Using this operation parameter, then in method set 18, the passenger classification is carried out, optionally through a link to further characteristics such as the ischial tuberosity spacing and a weight estimate. In method step 19, the passenger classification is conveyed to restraint system 4, so that restraint system 4 makes optimal use of restraint devices such as an airbag and a belt tensioner.

What is claimed is:

1. A method for performing a passenger classification in accordance with a seat mat in a vehicle seat, the seat mat including a matrix of pressure sensors, the method comprising the steps of:
recognizing the pressure sensors as matrix elements that include active and inactive matrix elements as a function of a load on the vehicle seat;
generating a seat profile;
generating a first one of result matrices from the inactive and active matrix elements;
generating further result matrices from existing result matrices in accordance with a logical operation;
subjecting adjoining matrix elements to the logical operation for the matrix elements;
for each individual one of the generated result matrices, generating a sum from the active matrix elements thereof;
weighting each sum by a corresponding factor, the weighted sums of the generated result matrices forming an operation parameter; and
performing the passenger classification in accordance with the operation parameter.

2. The method according to claim 1, wherein:
the logical operation includes an AND operation.

3. The method according to claim 1, further comprising the step of:
calculating each corresponding factor from a rank of a specific one of the generated result matrices, the rank indicating from how many of the generated result matrices the specific result matrix was calculated.

4. The method according to claim 1, further comprising the step of:
linking the operation parameter to at least one further characteristic of the seat profile for the passenger classification.

5. The method according to claim 4, wherein:
the at least one further characteristic includes a weight estimate.

6. The method according to claim 4, wherein:
the at least one further characteristic includes an ischial tuberosity spacing.

7. A device for performing a passenger classification, comprising:
a seat mat including a matrix, the matrix including pressure sensors; and
a processor for evaluating sensor signals and for carrying out the passenger classification.

8. The device according to claim 7, wherein:
the processor can be connected to a control unit for a restraint systems.
